(19) United States
(12) Patent Application Publication
(10) Pub. No.: US 2002/0129664 A1
(43) Pub. Date: Sep. 19, 2002

(54) Non-invasive real-time flow meter and related flow measuring method

(76) Inventors: James W. Jorgenson, Chapel Hill, NC (US); Keith E. Fadgen, Chapel Hill, NC (US); Luke T. Tolley, Chapel Hill, NC (US)

Correspondence Address: JENKINS & WILSON, PA, 3100 TOWER BLVD, SUITE 1400, DURHAM, NC, 27707, US

(21) Appl. No.: 09/760,919

(22) Filed: Jan. 16, 2001

(51) Int. Cl. G01F 1/708

(52) U.S. Cl. 73/861.95

(57) ABSTRACT

A flow meter enables a time-of-flight method for non-invasively measuring liquid flow in a fluid conduit. The flow meter comprises a perturbing element in the form of a phase changing device, a heat transfer device, an electrochemical perturbing device or a photochemical perturbing device, and a conductivity detection device spaced downstream from the perturbing element. The perturbing element is applied to a small section of the conduit to cause a perturbation in a portion of the liquid flowing therethrough. This perturbation causes a change in conductivity a liquid plug, and the affected liquid plug continuous to flow in the fluid conduit toward the conductivity detection device. The conductivity detection device then senses the change in conductivity resulting from the perturbation, and flow rate or velocity is determined from the time of detection and the distance between the point of perturbation and the point of conductivity change detection.

### TECHNICAL FIELD

The present invention relates generally to measuring of liquid flow in fluid conduits. More specifically, the present invention relates to non-invasive measuring of flow rate using time-of-flight techniques involving the detection of conductivity change in the liquid.

### BACKGROUND ART

Capillaries constructed from fused silica, polymers and other types of small-diameter tubes are utilized by scientists and researchers for a variety of purposes. One example is the performance of chemical separations for analytical purposes such as liquid chromatography. As will be appreciated by those skilled in the art, there exists a need to be able to monitor very low flow rates in real time inside of capillaries and small tubes in order to improve reproducibility in experimentation and analysis, and to troubleshoot problems commonly arising in these types of conduits. Standard techniques for measuring flow in large tubes are not applicable to smaller-scale tubes such as capillaries with low flow rates.

Several methods presently exist for measuring flow rate in capillaries, including time-of-flight flow monitoring with solvent additive, thermal time-of-flight flow monitoring with refractive index detection, and end-of-column solvent collection. Each of these conventional approaches suffers from drawbacks.

Time-of-flight flow monitoring with solvent additive does have several good characteristics. This technique can provide real-time measurements and, in certain implementations, does not require capillary modifications. There are, however, several disadvantages which limit the usefulness of this technique. First, it requires that a marker chemical be added to the solvent. Although this type of chemical is selected to interfere as little as possible with the analytes present in the column and with the chemistry occurring therein, it is impossible for the chemical additive to have no interference at all. The extra chemical present can also interfere with detection methods, especially mass spectrometry, a technique which is gaining in popularity as a detection method for microcolumn separations. The marker chemical can interfere with the ionization process and thus reduce the sensitivity of the detector. It is also likely that the marker chemical shows up in the mass spectra to give extra, unwanted peaks. Moreover, such solvent additives are typically detected by fluorescence measurements or other optical techniques, all of which are expensive and require precise alignment.

Thermal time-of-flight monitoring using a refractive index detector is a viable technique which meets many of the requirements for an ideal microcolumn flow sensor, but again there are several disadvantages to employing this method. A refractive index detector is a complex device which requires precise optical alignment, thus making it impractical for routine use. In addition, this technique often requires capillary modification in the form of an optical window for the refractive index detector. The technique has not been shown to perform with changing solvent conditions, such as a solvent gradient, since every solvent change also changes the refractive index. Moreover, the technique has not been shown to function at the low flow rates commonly encountered in capillary separation processes.

The technique of post-column collection of samples can be used to measure flow rate by weighing the liquid eluting from the tube. This procedure, however, is difficult to perform with small capillaries due to the extremely low flow rates and rapid solvent evaporation. Since this is a post-column technique, it cannot be used with post-column detectors such as mass spectrometry. The technique does not provide good real-time information, since a significant amount of solvent from the column must be gathered before the measurement can be obtained.

An ideal method for measuring flow rate in capillaries and other small tubes has the properties of being simple, not requiring capillary modification, not requiring solvent additives, giving real-time measurements, and being compatible with advanced separation and detection techniques such as those employed in mass spectrometry. Accordingly, the desirability of such improvements over existing flow metering technology can be readily appreciated by those skilled in the art.

The present invention is provided to solve these and other problems associated with the prior technology. As described hereinbelow, the present invention is characterized in part by its use of a contactless conductivity detection device. The use of contactless conductivity detectors in conjunction with capillary electrophoresis has been disclosed by Zemann et al. in “Contactless Conductivity Detection for Capillary Electrophoresis,” Analytical Chemistry, Vol. 70, No. 3, Feb. 1, 1998, pp. 563-567, in which cationic and anionic compounds are detected after capillary electrophoretic separation; by Fracassi da Silva et al. in “An Oscillometric Detector for Capillary Electrophoresis,” Analytical Chemistry, Vol. 70, No. 20, Oct. 15, 1998, pp. 4339-4343, in which an oscillometric detection cell is developed; and by Mayrhofer et al. in “Capillary Electrophoresis and Contactless Conductivity Detection of Ions in Narrow Inner Diameter Capillaries,” Analytical Chemistry, Vol. 71, No. 17, Sep. 1, 1999, pp. 3828-3833, in which the detector disclosed by Zemann et al. is further developed.

### DISCLOSURE OF THE INVENTION

Broadly stated, the present invention is provided to meet the need for accurate flow metering in fused silica capillaries, polymer capillaries and other small tubes or channels in which low flow rates typically occur, and to meet the ideal criteria delineated hereinabove. The present invention provides an apparatus for measuring low flow rates in capillaries in real time, without any modification to the capillary itself and without the need for solvent additives. The measuring apparatus provided in accordance with the present invention is compatible with most known detectors, including post-column detectors such as mass spectrometry. The real-time measurement of flow rate performed by the present invention enables real-time control of flow rate, thereby obtaining better results and reproducibility than heretofore known.

In particular, the present invention can be successfully and advantageously applied to small diameter capillaries and other tubes or channels, although it will be understood that application of the present invention is not limited to such systems. For purposes of the present invention and convenience, the term “capillary” as used herein is taken to mean any type of fluid conduit, such as a tube or a channel, having a small diameter. Preferably, the inside diameter of the capillary is approximately 1 mm or less. More preferably, the inside diameter is approximately 0.2 mm or less or, even more preferably, 0.05 mm or less.

The present invention can further be characterized as providing several variations of a time-of-flight method. Each method utilizes a device or component that produces a localized perturbing effect in a flowing liquid, and a conductivity detection device for detecting a change in conductivity resulting from the perturbation or disturbance. One specific embodiment can be characterized as an ionic concentration differential time-of-flight method, which utilizes a phase changing element in conjunction with a conductivity detection device. The phase changing element is applied to a small section of a capillary to rapidly change a portion of the liquid flowing therethrough into the solid or gas phase, which subsequently reverts back to the liquid phase. This rapid phase change causes ions to be displaced within the capillary. The conductivity detection device, which preferably is of the contactless type and is positioned downstream of the phase changing element, then senses a change in conductivity resulting from the displacement of ions in the liquid or solution flowing through the capillary. Other specific embodiments, described more fully hereinbelow, can be characterized as thermal, electrochemical and photochemical time-of-flight methods, respectively.

Since the flow monitoring device provided by the present invention does not require optical components (although optical means could be used to carry out some of the perturbing processes described hereinbelow), it can be made smaller than other types of monitoring devices. The device can be made small enough to be integrated onto a microchip if desired. The device requires no precise alignment or expensive components, thus rendering the device more robust and inexpensive in comparison to devices which require optics. Moreover, the device according to the present invention does not depend as heavily on the internal diameter of the capillary as do devices which rely on optical methods.

As will be appreciated by those skilled in the art, the real-time monitoring provided by the present invention of flow rate in capillaries or other small-diameter tubes is important for reproducibility, and allows a feedback system which can maintain a constant flow rate even with varying solvent and/or temperature conditions. The capabilities provided by the present invention allow for faster, more reproducible separations and make some separation techniques more practicable. One example is capillary electrophoresis (CE). CE has become fairly common in the past few years, but many persons skilled in the art have cited poor reproducibility as a deterrent to switching from liquid chromatography or other methods. The poor reproducibility observed by those skilled in the art is due mainly to ambient temperature fluctuations which cause a change in flow rate. The flow metering device provided in accordance with the present invention, however, allows for much greater reproducibility by either adjusting the flow rate through feedback or by simply informing the user of the current flow rate so that an adjustment can be made.

In one exemplary implementation, an instrument provided in accordance with the present invention can be utilized as a stand-alone device for measuring flow rate in capillaries or other small tubes such as capillary chromatography columns. The present invention can successfully function in conjunction with fused silica capillaries, polymer capillaries as well as other non-conductive tubing.

In another implementation, the device according to the present invention can be integrated into a system to function as part of a flow rate control loop.

Yet another implementation relates to the current interest in chip-based separations in which “lab-on-a-chip” devices are being developed. A flow sensor provided in accordance with the present invention can be integrated with a micro-fluidic device to monitor flow and provide diagnostics. Because the inventive device can be completely electrical in operative nature, the device can be built into the chip without any external components, thus making the device quite inexpensive and robust.

According to one embodiment of the present invention, a liquid flow meter apparatus comprises a fluid conduit including a non-conductive conduit wall, a perturbing device, and a conductivity detection device. The perturbing device is adapted to produce a localized perturbation in a liquid flowing through a section of the fluid conduit. The conductivity detection device is disposed adjacent to the conduit wall downstream of the perturbing device. In a preferred embodiment, a contactless conductivity detection device is provided wherein electrodes are disposed outside the conduit wall.

According to another embodiment of the present invention, a liquid flow meter apparatus comprises a fluid conduit including a non-conductive conduit wall, a perturbing device adapted to produce a localized perturbation in a liquid flowing through a section of the fluid conduit, and an AC signal source. The first and second electrodes are connected to the AC signal source. The first and second electrodes are disposed adjacent to the conduit wall downstream of the perturbing element and are axially spaced from each other.

According to yet another embodiment of the present invention, a liquid flow meter apparatus comprises a fluid conduit including a non-conductive conduit wall, a phase changing device, and a conductivity detection device disposed adjacent to the conduit wall downstream of the phase changing device. The phase changing device is adapted to change the phase of a portion of the liquid flowing through the fluid conduit.

According to still another embodiment of the present invention, a liquid flow meter apparatus comprises a fluid conduit including a non-conductive conduit wall, a heat transfer device, and a conductivity detection device disposed adjacent to the conduit wall downstream of the heat transfer device.

The heat transfer device is adapted to cause a transfer of heat in a portion of the liquid flowing through a section of the fluid conduit.

According to a further embodiment of the present invention, a liquid flow meter apparatus comprises a fluid conduit including a non-conductive conduit wall, an electrochemical perturbation device, and a conductivity detection device disposed adjacent to the conduit wall downstream of the electrochemical perturbation device. The electrochemical perturbation device is adapted to cause an electrochemical perturbation in a portion of the liquid flowing through a section of the fluid conduit.

According to a still further embodiment of the present invention, a liquid flow meter apparatus comprises a fluid conduit including a non-conductive conduit wall, a photochemical perturbation device, and a conductivity detection device disposed adjacent to the conduit wall downstream of the photochemical perturbation device. The photochemical perturbation device is adapted to cause a photochemical perturbation in a portion of the liquid flowing through a section of the fluid conduit.

According to an additional embodiment of the present invention, a method is provided for measuring the velocity or the rate at which a liquid is flowing through a fluid conduit. A liquid is conducted through a fluid conduit which includes a non-conductive wall. A volume of the liquid disposed in a first section of the fluid conduit is caused to undergo a perturbation. At a second section of the fluid conduit spaced downstream of the first section at a predetermined distance, a change in conductivity in the liquid is detected. This conductivity change occurs as a result of the perturbation. The perturbation produced by the present invention can involve an ionic concentration differential resulting from a change in the phase of the liquid, a thermal effect, an electrochemical effect, or a photochemical effect.

According to another embodiment of the present invention, a method is provided for measuring the velocity or the rate at which a liquid is flowing through a fluid conduit. A liquid is conducted through a fluid conduit which includes a non-conductive wall. At a first section of the fluid conduit, a displacement of ions is caused in the liquid to produce a zone of increased ionic concentration in the liquid and a zone of decreased ionic concentration in the liquid. At a second section of the fluid conduit spaced downstream of the first section at a predetermined distance, a change in conductivity in the liquid is detected. This change in conductivity occurs as a result of the ion displacement.

According to still another embodiment of the present invention, a method is provided for measuring the velocity or the rate at which a liquid is flowing through a fluid conduit. A fluid conduit having a non-conductive wall is provided. A volume of the liquid disposed in a first section of the fluid conduit is caused to undergo a perturbation. An AC signal source is provided. At a second section of the fluid conduit spaced downstream of the first section at a predetermined distance, at least two electrodes are placed adjacent to the conduit wall and in electrical communication with the AC signal source. An AC signal supplied from the AC signal source is capacitively coupled between the first electrode and the liquid, and between the second electrode and the liquid.

According to a further embodiment of the present invention, a “lab-on-a-chip” or a microfluidic device is adapted to perform conductivity change detection operations. The chip comprises a substrate, a fluid conduit formed on the substrate, and a conductivity detection device including at least two electrodes formed on the substrate. The fluid conduit preferably includes a non-conductive conduit wall. A perturbing device is provided for producing a localized perturbation in a liquid flowing through a section of the fluid conduit. The electrodes of the conductivity detection device are disposed adjacent to the conduit wall.

According to a still further embodiment of the present invention, a liquid flow monitoring and control apparatus comprises a fluid conduit including a conduit wall, a perturbing device, a conductivity detection device, a comparator device electrically communicating with the conductivity detection device, and a flow rate adjustment device operatively communicating with the comparator device. The perturbing device is adapted to produce a localized perturbation in a liquid flowing through a section of the fluid conduit. The conductivity device is operatively disposed downstream of the perturbing device in relation to the fluid conduit. The comparator device is adapted to compare a value indicative of measured flow rate with a value indicative of preset flow rate.

It is therefore an object of the present invention to provide an accurate liquid flow metering apparatus adapted to operate non-invasively on fluid conduits.

It is another object of the present invention to provide a non-invasive flow-metering apparatus which is particularly advantageous in measuring low flow rates typically encountered in capillaries and other small-diameter tubes.

Some of the objects of the invention having been stated hereinabove, other objects will become evident as the description proceeds when taken in connection with the accompanying drawings as best described hereinbelow.

### BRIEF DESCRIPTION OF THE DRAWINGS

FIG. 1 is a schematic diagram of a flow metering apparatus provided in accordance with the present invention;

FIG. 2A is a schematic diagram illustrating an example of a phase changing process accomplished by the present invention, in which a burst of cold fluid is applied to a capillary;

FIG. 2B is a schematic diagram illustrating the phase changing process, in which a portion of the liquid in the capillary freezes and ions are displaced;

FIG. 2C is a schematic diagram illustrating the phase changing process, in which the frozen portion of the liquid in the capillary melts and results in a zone of lower ionic concentration;

FIGS. 3A, 3B and 3C are respective sequential schematic diagrams of the flow metering apparatus illustrated in FIG. 1 during operation thereof;

FIG. 4A is a schematic diagram of a contactless conductivity detection device provided as part of the flow metering apparatus illustrated in FIG. 1 during operation thereof, illustrating the capacitive coupling of an AC signal to the core of a capillary;

FIG. 4B is a schematic diagram of the contactless conductivity detection device during operation thereof, illustrating the conduction of the AC signal through the core of the capillary;

FIG. 4C is a schematic diagram of the contactless conductivity detection device during operation thereof, illustrating the capacitive coupling of the AC signal out of the core of the capillary;

FIG. 5 is a schematic diagram of an equivalent electrical circuit modeling the conductivity detection device illustrated in FIGS. 4A, 4B, and 4C;

FIG. 6 is a schematic diagram of a testing arrangement set up for purposes of evaluating of the flow metering apparatus illustrated in FIG. 1;

FIG. 7 is an output trace produced as a result of the operation of the flow metering apparatus;

FIG. 8 is a plot of linear velocity of the liquid flowing through the capillary, as measured by the flow metering apparatus, as a function of fluid pressure;

FIG. 9 is a plot of the volumetric liquid flow rate of the liquid flowing through the capillary, as measured by a testing apparatus, as a function of fluid pressure and obtained for the purpose of validating the operation of the flow metering apparatus;

FIG. 10 is a plot of linear velocity calculated from the flow rate measured by the testing apparatus referred to in FIG. 9 versus linear velocity measured by the flow metering apparatus;

FIG. 11 is a schematic diagram of a flow metering apparatus provided in accordance with another embodiment of the present invention;

FIG. 12 is a schematic diagram of the flow metering apparatus provided in accordance with yet another embodiment of the present invention;

FIG. 13 is a topological diagram of a chip or a region thereof in which a flow metering apparatus is integrated in accordance with the present invention; and

FIG. 14 is a schematic diagram illustrating an application of the present invention providing real-time control of flow rate in a capillary electrophoresis process.

### DETAILED DESCRIPTION OF THE INVENTION

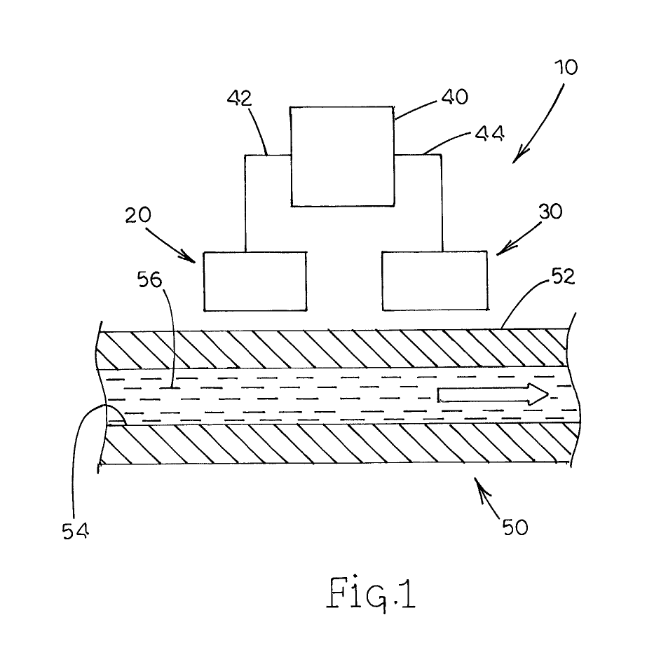

Referring now to FIG. 1, a non-limiting example is illustrated of a flow metering apparatus, generally designated 10, according to the present invention. Flow metering apparatus 10 is designed to non-invasively measure liquid flow rate in real-time inside of fused silica or other non-conductive capillaries (as defined hereinabove) by means of a localized perturbation caused in the liquid flowing in the capillary. This perturbation generally flows with the liquid for a period of time before dissipating or returning to equilibrium. Hence, the perturbation or its effect on the liquid can be detected through the positioning of an appropriate detection device spaced downstream at a suitable distance from the point at which the perturbation is caused. Flow metering apparatus 10 can be broadly described as a liquid flow meter comprising two primary components: a perturbing element, generally designated 20, and a conductivity detection device (or conductivity detector), generally designated 30. Conductivity detector 30 preferably has a contactless design and thus is non-invasive with respect to the liquid or its conduit. Flow metering apparatus 10 operates in conjunction with a capillary 50 whose capillary wall 52 defines a generally cylindrical, hollow capillary core 54 through which a liquid 56 flows. Such liquid 56 could be a solution, a solvent, or some other type of fluid. In FIG. 1, the direction of fluid is arbitrarily illustrated by the arrow as being from left to right. Conductivity detection device 30 is disposed at a location downstream of perturbing element 20. A computer or other electronic processing device 40 and any associated control and/or signal conditioning and amplification circuitry can be provided to communicate with both perturbing element 20 and conductivity detector 30 over electrical lines 42 and 44, respectively, and thus coordinate the timing of the respective functions of perturbing element 20 and conductivity detector 30.

In one embodiment, flow metering apparatus 10 measures liquid flow rate based on an ion displacement due to a temporary phase change deliberately caused in the liquid flowing in capillary 50. In this embodiment, perturbing element 20 is provided in the form of a phase changing element which, for purposes of describing the present embodiment, will also be designated 20 as shown in FIG. 1.

Phase changing element 20 is provided in the form of a heating or cooling unit adapted to induce a phase change in a volume or plug of liquid 56 flowing through capillary 50 at some region of capillary 50. That is, phase changing element 20 can alternatively be provided as a rapid heating unit capable of boiling liquid 56 in capillary 50, or as a rapid cooling unit capable of at least partially freezing liquid 56. Several types of rapid heating or cooling units could be provided to serve as phase changing element 20. Non-limiting examples of suitable means for effecting rapid heating include providing an external heat source, dielectric heating, microwave heating, inductive heating, and light absorption. Non-limiting examples of suitable means for effecting rapid cooling include spraying refrigerated liquid, Joule-Thompson cooling, and using Peltier cooling devices. In the broad context of the present invention, the exact mechanism used is not important, so long as the phase change can be effected rapidly to a small section of capillary 50 and then be rapidly returned to the liquid phase.

The rapid heating or cooling of liquid 56 in capillary 50 creates a sharp ionic concentration boundary in the heated or cooled liquid plug, and thereby facilitates detection. Due to the short section of capillary 50 involved in the phase change operation and the rapid heat transfer of small conduits, the phase change can be a short event which does not greatly affect other processes occurring in capillary 50. Indeed, it is preferable to heat or cool the liquid for only a short amount of time in order to allow repeated measurements to be performed quickly.

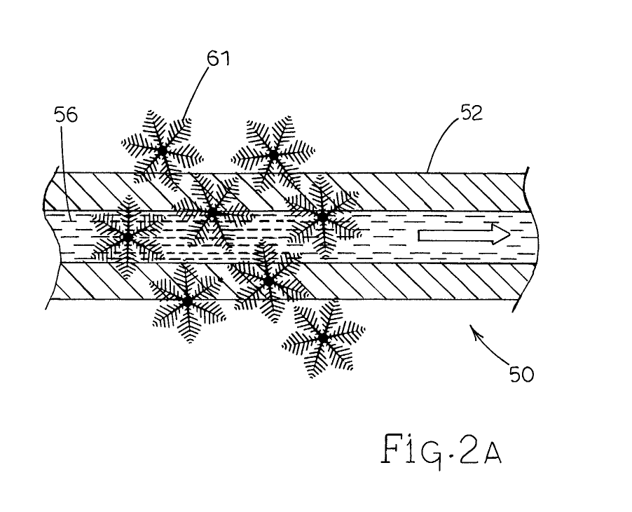

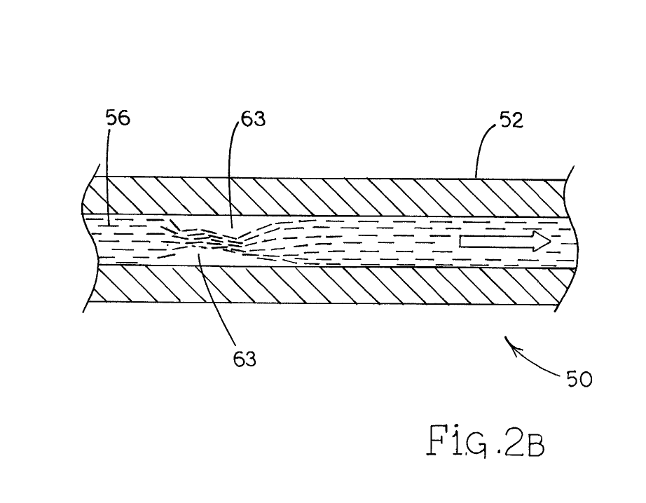

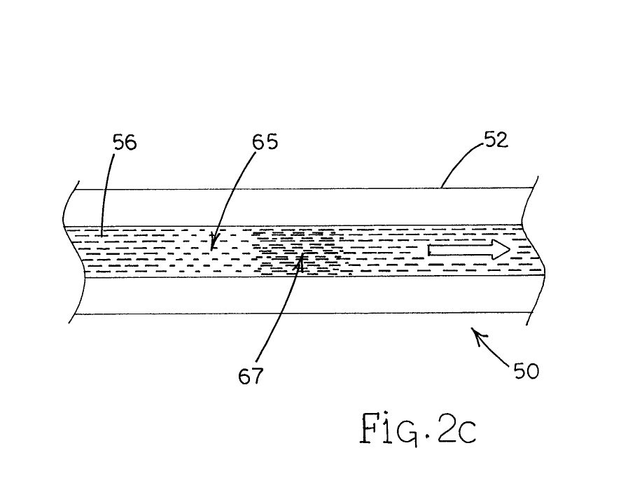

The operation of phase changing element 20 is illustrated generally in FIGS. 2A-2C. Referring specifically to FIG. 2A, in order for flow metering apparatus 10 to measure flow rate, phase changing element 20 is activated for a short amount of time to either freeze or boil a small plug of liquid 56 flowing in capillary 50. In the specific embodiment illustrated, a burst of cold fluid 61 has been applied to capillary 50. Referring to FIG. 2B, the liquid plug is subject to indirect thermal contact with the cold burst primarily through a combination of conductive and convective heat transfer modes. Consequently, at least a portion 63 of the liquid plug temporarily freezes into a solid phase. This phase change process displaces ions present in the liquid plug. Referring to FIG. 2C, the solid phase material melts soon thereafter. The rapid phase change occurring during this process causes a region or zone of higher ionic concentration in solution 56 to form either before or after liquid plug, and a region or zone of lower ionic concentration generally within the central vicinity of liquid plug itself. In FIG. 2C, the region of lower ionic concentration is generally designated 65 and the region of higher ionic concentration is generally designated 67. In the case where the liquid plug temporarily freezes, it is believed at the present time that salts are separated out from the liquid plug and lead to the creation of zone of higher ionic concentration 67.

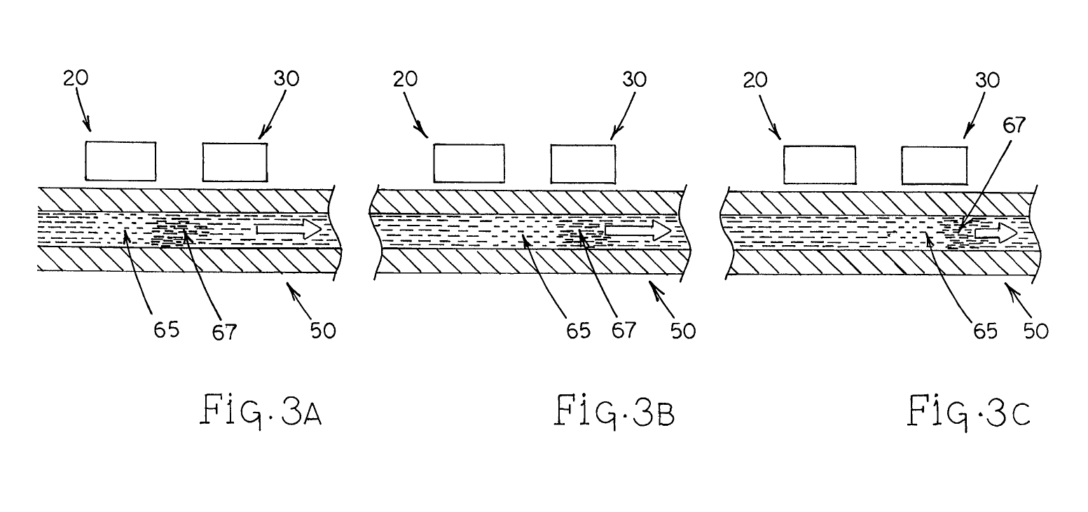

Referring to FIG. 3A, contactless conductivity detection device 30, having first been positioned downstream of phase changing element 20, is activated after the phase change occurs. This activation may be accomplished by providing a timer or clock (for example, using computer 40 in FIG. 1) that is initiated upon operation of phase changing element 20. As shown in FIG. 3B, region 65 of lower ionic concentration associated with the melted liquid plug continues to flow through capillary 50 toward conductivity detector 30. Due to the regions of higher and lower ionic strength now residing in capillary 50, when these regions reach conductivity detector 30 as shown in FIG. 3C, conductivity detector 30 can detect the change in conductivity resulting from this ionic strength differential. By accurately knowing the distance between phase changing element 20 and conductivity detector 30, the flow rate of the liquid can be calculated from the period of time the differing ionic regions take to traverse this distance.

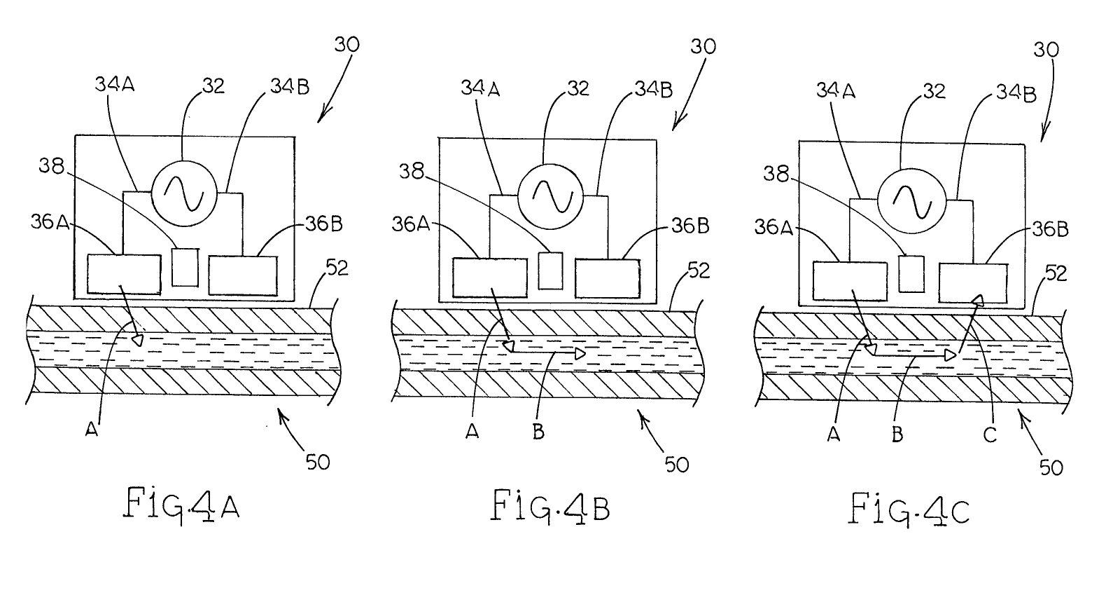

Referring to FIGS. 4A-4C, contactless conductivity detection device 30 includes an AC signal source 32 electrically coupled by lead wires 34A and 34B, respectively, to two electrodes 36A and 36B disposed in proximity to each other and mounted adjacent to the outside of capillary wall 52. Electrodes 36A and 36B are spaced at a distance from each other, and preferably are provided in the form of metallic bands or tubes which are coaxially disposed about capillary wall 52. Contactless conductivity detection device 30 essentially functions by applying an AC signal to these electrodes 36A and 36B, and by capacitively coupling the AC voltage to conductive solution 56 across the dielectric material which forms capillary wall 52. A shield 38 is preferably interposed between electrodes 36A and 36B to reduce their direct capacitive coupling to each other. In preferred embodiments, shield 38 is constructed from a brass or copper material.

While the non-invasive, contactless design described hereinabove for conductivity detection device 30 is preferred, it will be understood that the electrodes employed in the present invention could be installed through capillary wall 52 such that the ends of the electrodes are in direct contact with solution 56.

As a result of the design of contactless conductivity detection device 30 and the dielectric properties of capillary wall 52, the AC signal is capacitively coupled between electrode 36A and the conductive liquid in capillary core 54. Referring specifically to FIG. 4A, this capacitive coupling is depicted by arrow A. Referring to FIG. 4B, a potential difference is established within capillary core 54 and causes a current to be conducted through the liquid in the direction generally represented by arrow B. Referring to FIG. 4C, when the current reaches the vicinity of other electrode 36B, the AC signal is capacitively coupled out as depicted by arrow C. Since the capacitance of capillary wall 52 remains fairly constant, the conductivity of the liquid between the two electrodes 36A and 36B is measured without direct contact or the need to perform modifications to capillary 50.

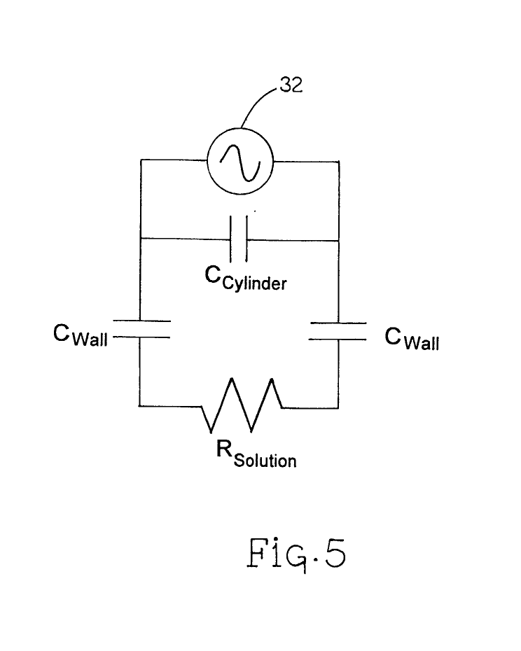

Referring to FIG. 5, the equivalent circuit for conductivity detector 30 is illustrated. AC signal source 32 is placed in parallel with the electrical resistance of the solution flowing through capillary 50. This resistance is represented by a resistor Rₛₒₗᵤₜᵢₒₙ. Given that resistance varies with temperature and is inversely related to conductance, the present invention could be characterized as being adapted to measure the value for resistor Rₛₒₗᵤₜᵢₒₙ. The capacitance of capillary wall 52 at each electrode 36A and 36B is represented by capacitor C_{wall}, and is placed in series with each lead connection of AC signal source 32. This capacitance accounts for the capacitance of that portion of capillary wall 52 between electrode 36A or 36B and conductive solution 56. As described hereinabove, capillary wall 52 is constructed from a non-conductive material such as silica glass. Capillary wall 52 is therefore a dielectric material which, rather than conducting current, can only allow electrical charges to accumulate on electrode 36A or 36B and in adjacent solution 56. AC signal source 32 is also placed in parallel with a capacitor C_{cylinder}. This circuit element accounts for both the direct capacitance of capillary wall 52 (i.e., electrode 36A through capillary wall 52 to electrode 36B) and the capacitance of capillary wall 52 plus that of solution 56 (i.e., electrode 36A through capillary wall 52 through solution 56 through capillary wall 52 to electrode 36B). Under most conditions, the magnitude of capacitor C_{cylinder} will be negligible in comparison to the magnitude of capacitor C_{wall}.

### EXAMPLE

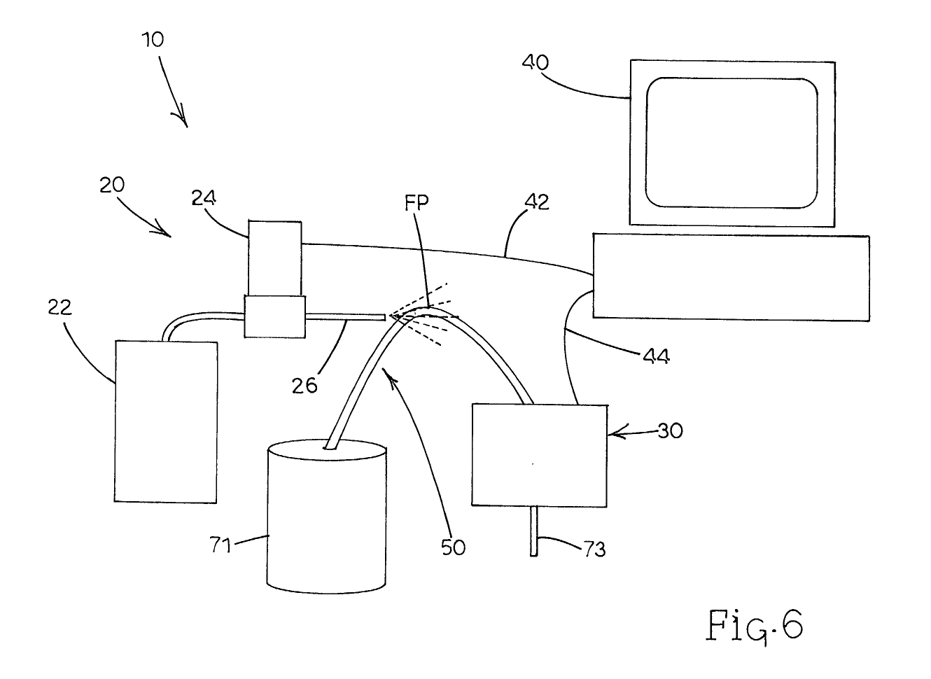

FIG. 6 illustrates an initial test setup for exemplary flow metering apparatus 10 with an arrangement of primary components employed therefor. Phase changing element 20 is provided in the form of a rapid cooling unit. Phase changing element 20 generally includes a vessel 22 containing a supply of pressurized heat transfer fluid and a solenoid valve 24 in fluid communication therewith. Actuation of solenoid valve 24 is controlled by an appropriate control signal fed over an electrical line 42 from a computer or other suitable electronic processing device 40. The output side of solenoid valve 24 fluidly communicates with a heat transfer fluid ejection component 26, which could be a nozzle or orifice. Ejection component 26 is directed at a section of capillary 50 where the phase change is desired to occur, which in the present example may be termed a freezing point FP of capillary 50. A suitable rapid cooling unit is a GUST AIR DUSTER™ unit, which is commercially available from Stoner Company in Quarryville, Pa. The operation of this particular cooling unit is based on the extremely fast expansion and evaporation of the initially compressed heat transfer fluid out of ejection component 26, which causes a rapid rejection of heat energy out of the liquid in capillary 50 at freezing point FP according to known thermodynamic principles.

Capillary 50 has a 110 cm length and 50 μm inner diameter. One end of capillary 50 is connected to a pressurized reservoir 71, which supplies a buffered solution or other liquid to be transported through capillary 50. In this particular test setup, a distal end 73 of capillary 50 conducts liquid to waste. Conductivity detector 30 is disposed with its electrodes 36A and 36B operatively positioned with respect to capillary 50, as described hereinabove with reference to FIGS. 4A-4C. In this particular test setup, conductivity detector 30 is accurately spaced at a known distance from freezing point FP. In order to time the respective operations of phase changing element 20 and conductivity detector 30, conductivity detector 30 communicates with computer 40 over an electrical line 44.

A test run utilizing the arrangement described hereinabove can be conducted as follows. A small amount of heat transfer fluid stored in vessel 22 is sprayed onto a short section of capillary 50, i.e., at freezing point FP. The ejected heat transfer fluid quickly evaporates, freezing this section of capillary 50 in the process. The output from conductivity detector 30 is then monitored for the peak and trough values which respectively indicate the regions of high and low ionic strength in the liquid flowing through capillary 50.

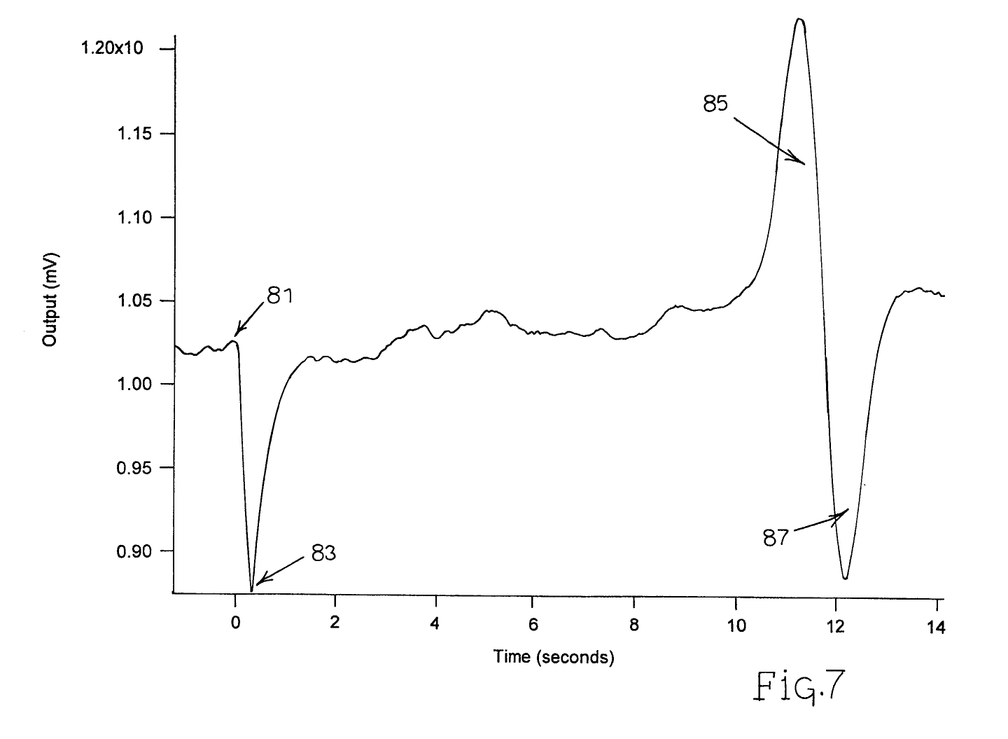

FIG. 7 illustrates an example of a typical output trace generated by conductivity detector 30 as a result of the phase change occurring at freezing point FP upstream of conductivity detector 30. The output trace is a plot of voltage in microvolts as a function of time in seconds, with the “0” value on the x-axis corresponding to the time of activation of phase changing element 20. The output trace includes a point 81 at which the freezing pulse was applied, and a point 83 at which flow resumed. The output trace describes a region of increased ionic strength, generally designated 85, under the peak value, and a region of decreased ionic strength, generally designated 87, above the trough value.

The peak travel times from several trial runs at six different fluid pressures (10, 12, 15, 18, 20, and 25 psi) are listed in Table 1 below. For the test runs corresponding to the first three pressures, the spacing between conductivity detector 30 and freezing point FP was 7 cm. For the test runs corresponding to the last three pressures, the spacing was 7.3 cm. Values for standard deviation and percent standard deviation are also given in Table 1 for each group of test runs corresponding to each pressure. In order to obtain more reproducible results, capillary 50 was held in a heated brass block to accelerate the thawing of the frozen section of capillary 50. This addition decreased the standard deviation of the measurements to less than 1%, and made data analysis much easier due to the increased sharpness in the output signal.

TABLE 1

| | | | | Distance |
|---|---|---|---|---|
| Pressure | Time (sec) | (mm/sec) | | (cm) |
| 10 | 22.6 | 3.10 | Stdev | 7 |
| 10 | 22.6 | 3.10 | 0.01 | |
| 10 | 22.6 | 3.10 | % Stdev | |
| 10 | 22.6 | 3.10 | 0.40 | |
| 10 | 22.4 | 3.13 | | |
| 15 | 12.4 | 5.65 | Stdev | |
| 15 | 12.3 | 5.69 | 0.05 | |
| 15 | 12.1 | 5.79 | % Stdev | |
| 15 | 12.2 | 5.74 | 0.87 | |
| 15 | 12.3 | 5.69 | | |
| 15 | 12.3 | 5.69 | | |
| 15 | 12.4 | 5.65 | | |
| 20 | 8.8 | 7.95 | Stdev | |
| 20 | 8.7 | 8.05 | 0.08 | |
| 20 | 8.6 | 8.14 | % Stdev | |
| 20 | 8.65 | 8.09 | 1.04 | |
| 20 | 8.7 | 8.05 | | |
| 20 | 8.6 | 8.14 | | |
| 20 | 8.5 | 8.24 | | |
| 20 | 8.6 | 8.14 | | |
| 12 | 17.65 | 4.14 | Stdev | 7.3 |
| 12 | 17.6 | 4.15 | 0.02 | |
| 12 | 17.5 | 4.17 | % Stdev | |
| 12 | 17.65 | 4.14 | 0.42 | |
| 12 | 17.5 | 4.17 | | |
| 12 | 17.6 | 4.15 | | |
| 12 | 17.45 | 4.18 | | |
| 12 | 17.55 | 4.16 | | |
| 18 | 10.45 | 6.99 | Stdev | |
| 18 | 10.45 | 6.99 | 0.09 | |
| 18 | 10.4 | 7.02 | % Stdev | |
| 18 | 10.25 | 7.12 | 1.32 | |
| 18 | 10.25 | 7.12 | | |
| 18 | 10.1 | 7.23 | | |
| 18 | 10.15 | 7.19 | | |
| 18 | 10.2 | 7.16 | | |
| 25 | 7.4 | 9.86 | Stdev | |
| 25 | 7.3 | 10.00 | 0.10 | |
| 25 | 7.2 | 10.14 | % Stdev | |
| 25 | 7.25 | 10.07 | 0.99 | |
| 25 | 7.3 | 10.00 | | |
| 25 | 7.3 | 10.00 | | |
| 25 | 7.3 | 10.00 | | |
| 25 | 7.3 | 10.00 | | |
| 25 | 7.2 | 10.14 | | |
| 25 | 7.25 | 10.07 | | |
| 25 | 7.3 | 10.00 | | |
| 25 | 7.25 | 10.07 | | |
| 25 | 7.1 | 10.28 | | |

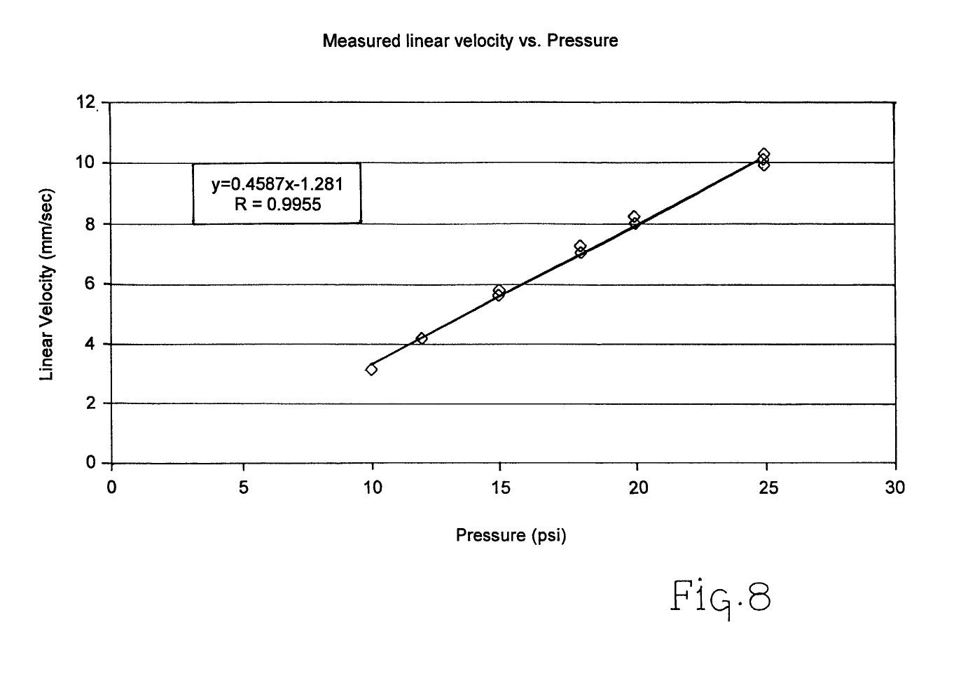

FIG. 8 is a graph of data corresponding to Table 1, showing linear velocity in mm/sec measured by flow metering apparatus 10 as a function of pressure in psi. FIG. 8 demonstrates the good linearity of the test results.

in order to validate these measured flow rates, the volumetric flow through capillary 50 was measured by connecting a small syringe to the output of capillary 50 and recording the amount of time required for the meniscus to move a certain distance. Again, capillary 50 illustrated in FIG. 6 was used, with a length of 110 cm, an inner diameter of 50 μm, and a cross-sectional flow area of about 2.0E-05 cm². This validation procedure was performed several times at three different pressures. The data are given in Table 2 below.

TABLE 2

| | | | | Calculated | |
|---|---|---|---|---|---|
| | | | Calculated | Linear | |
| Pressure | Time | Volume | Flow Rate | Velocity | Travel time |
| (psi) | (sec) | (μL) | (μL/min) | (mm/sec) | (sec) |
| 15 | 194 | 2.5 | 0.773 | 6.6 | 7.7 |
| 15 | 202 | 2.5 | 0.743 | 6.3 | |
| 15 | 157 | 2 | 0.764 | 6.5 | |
| 20 | 85 | 1.5 | 1.059 | 9.0 | 5.5 |
| 20 | 140 | 2.5 | 1.071 | 9.1 | |
| 20 | 83 | 1.5 | 1.084 | 9.2 | |
| 30 | 34.8 | 1 | 1.724 | 14.6 | 3.4 |
| 30 | 140 | 4 | 1.714 | 14.6 | |

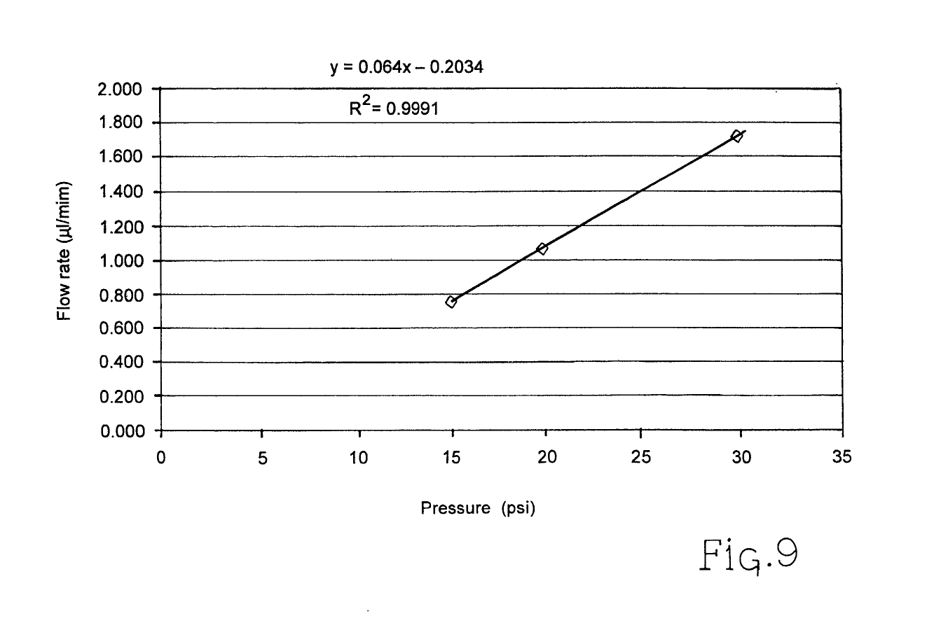

FIG. 9 is a graph corresponding to Table 2, demonstrating the linearity of the results. A comparison of the measured linear velocities in FIG. 8 to the calculated linear velocities based on the measured volumetric flow rate in FIG. 9 shows a good correlation, which indicates that flow metering apparatus 10 successfully and accurately measures flow rates as intended.

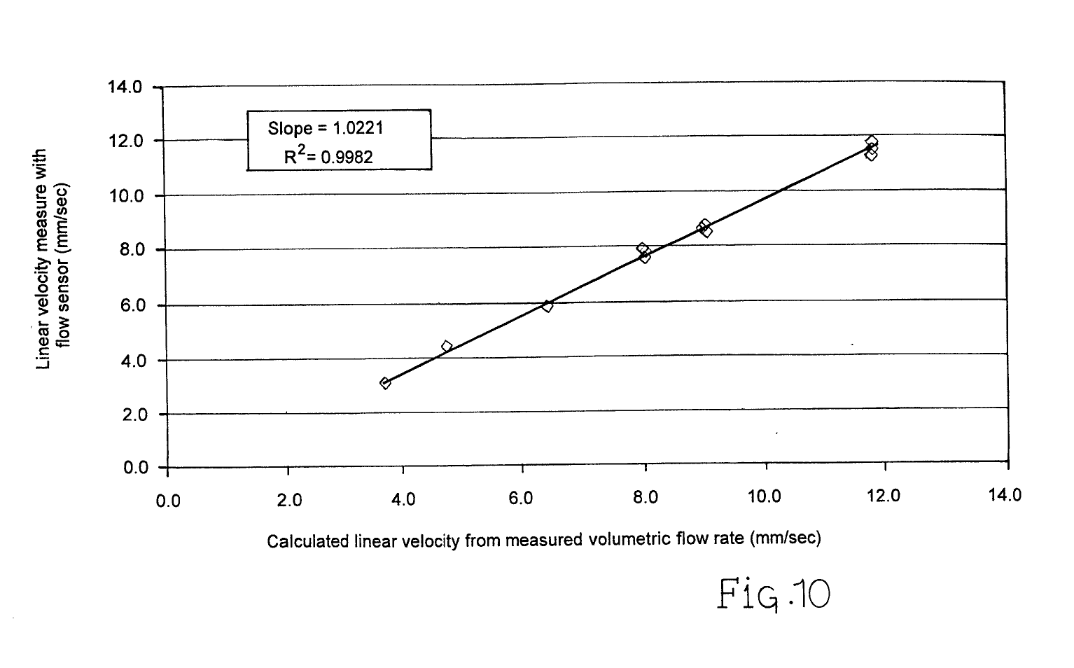

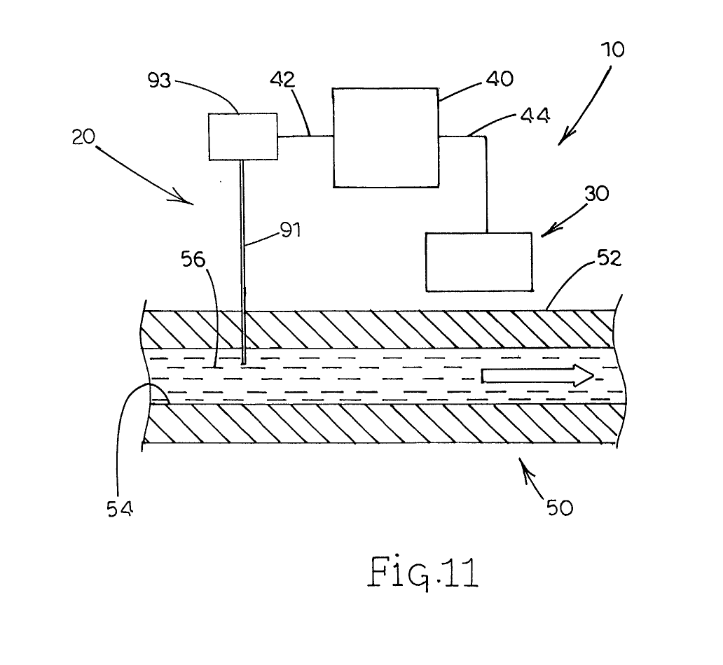

In FIG. 10, the linear velocities measured with flow metering apparatus 10 are compared to the linear velocities calculated from the measured volumetric flow rate. This direct comparison illustrates that flow metering apparatus 10 is functioning as intended, and helps to counter inaccuracies in other measurements. If the pressure gauge used to supply the gas pressure to give the flow were inaccurate, then this would cause errors in all the calculations of flow rates based on this reading. If, however, the flow rate is measured using two different methods which use the same (and possibly erroneous) pressure measurement, these two numbers can be directly compared to each other. This is because the problematical value is the same in each case and will affect each calculation in the same way. This comparison of measure linear velocities should generate a straight line with a slope of 1. In the comparison shown in FIG. 10, the slope using these two methods does indeed generate a slope of very nearly 1—specifically, 1.0221.

It should be noted that because the inventive technique described hereinabove is based on detecting a plug of solvent having a different ionic strength than that of the balance of the solvent, ions must be present in the solvent. If, for instance, the solvent is de-ionized water or a non-polar organic liquid, then there would not be enough ions present to detect the small change that the inventive flow sensor detects. The solvent must also contain a component that is either easily vaporized or frozen in order to create a plug of different ionic strength. The present invention has been successfully practiced in conjunction with aqueous solvents with different ions and additives, which solvents are used in approximately ninety percent of the chromatography procedures performed.

It should also be noted that the inventive technique requires that the liquid in the capillary undergo a phase change. This phase change requires a temperature very different from the ambient air. Such a temperature change could have detrimental effects on any analytes present. Freezing has been found to be much gentler on analytes than heating. Freezing, however, introduces the possibility of freezing the entire plug of liquid in the capillary, which event would briefly stop the flow. While freezing does need to occur, the entire plug does not need to be frozen and the liquid does not need to stay frozen for a significant length of time. Accordingly, if excessive freezing is observed to be a problem in a given application of the present invention, the problem can be overcome with the addition of a heater to rapidly thaw the capillary or with more precise timing that prevents full freezing in the first place.

Referring back to FIG. 1, in addition to the above-described ionic concentration differential time-of-flight technique, the present invention can also be implemented as a thermal time-of-flight technique. In this embodiment, perturbing element 20 is provided in the form of a heating or cooling unit which, on a localized basis, adds heat to the liquid plug or removes heat from the liquid plug but in either case does not transfer enough energy to effect a phase change. The conductivity of the liquid is a function of temperature, and thus any temporary change in conductivity resulting from the heating or cooling pulse applied to the liquid plug can be rapidly detected by conductivity detector 30.

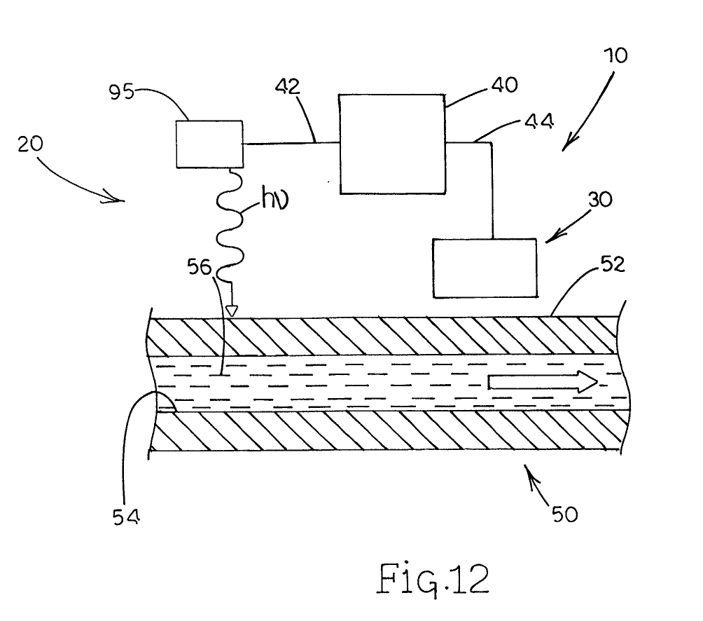

Referring now to FIG. 11, a further embodiment of the present invention is illustrated in which an electrochemical time-of-flight technique is implemented. In this embodiment, perturbing element 20 is provided in the form of one or more electrodes 91 inserted directly into capillary 50 in contact with solution 56. A discrete pulse of electrical energy supplied from an electrical source 95 causes an electrochemical disturbance in a localized region of solution 56. One effect of this disturbance is a change in conductivity in the liquid plug, which can be detected by conductivity detector 30.

Referring to FIG. 12, an additional embodiment of the present invention is illustrated in which a photochemical time-of-flight technique is implemented. In this embodiment, perturbing element 20 is provided in the form of a light source 91 such as a laser that directs a pulse of light energy hv at the liquid plug flowing through capillary 50. As a consequence of the photochemical disturbance caused by perturbing element 20 in this embodiment, the liquid plug undergoes a change in conductivity which is detected by conductivity detector 30.

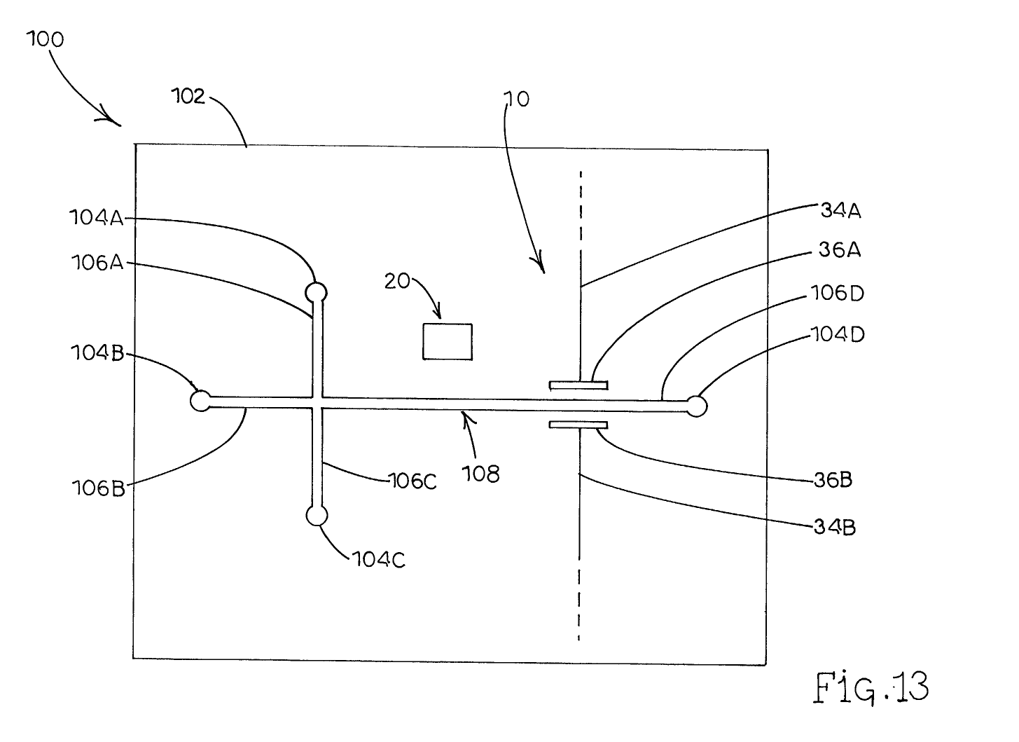

Referring to FIG. 13, a simplified topology of a “lab-on-a-chip” device, generally designated 100, such as a microfluidic device, is illustrated. In accordance with this embodiment of the present invention, flow metering apparatus 10 according to any of the embodiments described hereinabove has been integrated onto a substrate 102. Substrate 102 represents either a full layer of chip device 100 or at least a region thereof. One or more reservoirs 104A-104D are formed on or in substrate 102 and are interconnected by fluid channels 106A-106D. In a non-limiting example, reservoir 104A receives and contains an analyte sample of interest, reservoir 104B receives and contains a solvent, reservoir 104C receives collects waste, and reservoir 104D serves as an outlet. In this case, fluid channel 106D serves a function similar to that of fluid conduit or capillary 50 illustrated in FIGS. 1 and 2. Additionally, electrodes 36A and 36B and their respecting lead connections 34A and 34B, as part of conductivity detector 30, are integrated onto substrate 102, either in the arrangement shown in FIG. 13 or in that shown in FIG. 4. Perturbing element 20, in one of the forms described hereinabove, is also integrated in or on chip in order to produce a controlled perturbation effect in a liquid plug flowing through capillary 50 at a point of perturbation 108. A highly miniaturized liquid flow meter is thereby provided. Chip device 100 and its associated components as described herein can be fabricated and assembled according to principles known to those skilled in the art.

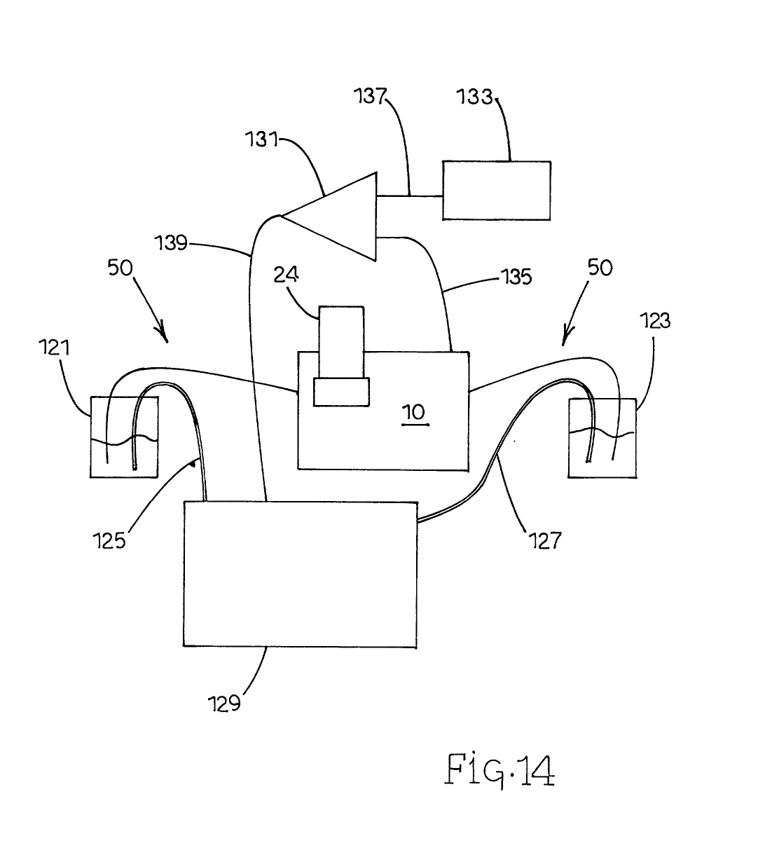

Referring now to FIG. 14, flow metering apparatus 10 can be implemented as a flow sensor for real-time control of liquid flow rate in any number of applications. In the specific, non-limiting example illustrated in FIG. 14, flow metering apparatus 10 is utilized to monitor and control liquid flow rate during capillary electrophoresis (CE) runs. In the basic arrangement illustrated, capillary 50 runs from a buffer supply reservoir 121 or equivalent component, through flow metering apparatus 10 including its associated components as described for the several embodiments hereinabove, and to a waste reservoir 123 or equivalent component. As understood by those skilled in the art of CE techniques, wires 125 and 127 run from a high-voltage power supply 129 to the solutions in reservoirs 121 and 123, respectively, to apply a voltage potential across capillary 50. Control of flow rate is enabled by providing a comparator 131 and associated circuitry, or its equivalent, and an interface 133 and associated circuitry for establishing a set point for the flow rate. Comparator 131 communicates with flow metering apparatus 10 over electrical line 135, with set point interface 133 over electrical line 137, and with power supply 129 over electrical line 139.

Flow metering apparatus 10 monitors flow rate in capillary 50 according to one of the methods disclosed hereinabove, produces a signal indicative of the measured flow rate, and sends this signal to comparator 131. At predetermined time intervals, the signal for measured flow rate is compared to the set point signal received from set point interface 133. If the actual measured flow rate has deviated from the desired set point, an error or tolerance value is established in a manner known by those skilled in system control and circuit design, and a control signal is generated to make the adjustment needed to bring the actual flow rate back to the desired set point value. For instance, a control signal can be sent over electrical line 139 to power supply 129 to change the applied voltage and thus the flow rate. In other situations, a control signal would be provided to adjust fluid pressure or a pump or any other means by which liquid is caused to flow through capillary 50.

It should be noted that conductivity detection device 30, when provided in its contactless form, only works with tubes that are non-conductive. Many of the columns and connecting tubes currently used are made of stainless steel which would not allow this device to be used. These limitations are inherent in the operation of the device and cannot be overcome unless a non-conductive section of capillary or tubing is installed.

It will be understood that various details of the invention may be changed without departing from the scope of the invention. Furthermore, the foregoing description is for the purpose of illustration only, and not for the purpose of limitation—the invention being defined by the claims.

What is claimed is:

1. A liquid flow meter apparatus comprising:
(a) a fluid conduit including a non-conductive conduit wall;
(b) a perturbing device adapted to produce a localized perturbation in a liquid flowing through a section of the fluid conduit; and
(c) a conductivity detection device disposed downstream of the perturbing device in relation to the conduit wall.

2. The apparatus according to claim 1 wherein the conduit wall is constructed from a fused silica material.

3. The apparatus according to claim 1 wherein the conduit wall has an inside diameter of approximately 1 mm or less.

4. The apparatus according to claim 3 wherein the conduit wall has an inside diameter of approximately 0.2 mm or less.

5. The apparatus according to claim 4 wherein the conduit wall has an inside diameter of approximately 0.05 mm or less.

6. The apparatus according to claim 1 wherein the perturbing device includes a phase changing device adapted to change the phase of a portion of the liquid flowing through the fluid conduit.

7. The apparatus according to claim 6 wherein the phase changing device includes a rapid cooling unit.

8. The apparatus according to claim 7 wherein the rapid cooling unit includes a source of pressurized heat transfer fluid and an outlet member adapted to emit at least a portion of the heat transfer fluid toward a section of the fluid conduit.

9. The apparatus according to claim 6 wherein the phase changing device includes a rapid heating unit.

10. The apparatus according to claim 1 wherein the perturbing device includes a heat transfer device adapted to cause a transfer of heat in a portion of the liquid flowing through a section of the fluid conduit.

11. The apparatus according to claim 10 wherein the heat transfer device includes a heating unit.

12. The apparatus according to claim 10 wherein the heat transfer device includes a cooling unit.

13. The apparatus according to claim 1 wherein the perturbing device includes an electrochemical perturbation device adapted to cause an electrochemical perturbation in a portion of the liquid flowing through a section of the fluid conduit.

14. The apparatus according to claim 13 wherein the electrochemical perturbation device includes an electrode inserted into the fluid conduit in contact with the liquid flowing through the fluid conduit.

15. The apparatus according to claim 1 wherein the perturbing device includes a photochemical perturbation device adapted to cause a photochemical perturbation in a portion of the liquid flowing through a section of the fluid conduit.

16. The apparatus according to claim 15 wherein the photochemical perturbation device includes a light-emitting device adapted to direct light energy towards the section of the fluid conduit.

17. The apparatus according to claim 16 wherein the light-emitting device includes a laser.

18. The apparatus according to claim 1 wherein the conductivity detection device includes an AC signal source and first and second electrodes connected to the AC signal source, wherein the first and second electrodes are disposed adjacent to the conduit wall and are axially spaced from each other.

19. The apparatus according to claim 18 wherein at least one of the first and second electrodes is a metal band disposed coaxially about the conduit wall.

20. The apparatus according to claim 18 wherein the conductivity detection device includes an electrically isolating shield disposed between the first and second electrodes.

21. The apparatus according to claim 18 wherein the first and second electrodes are radially spaced from an outer surface of the conduit wall to form a contactless conductivity detection device.

22. The apparatus according to claim 18 wherein the first and second electrodes are at least partially disposed within the fluid conduit.

23. The apparatus according to claim 1 comprising an electronic control device electrically communicating with the perturbing device and the conductivity detection device and adapted to control respective operations of the perturbing device and the conductivity detection 20 device.

24. A liquid flow meter apparatus comprising:
(a) a fluid conduit including a non-conductive conduit wall;
(b) a perturbing device adapted to produce a localized perturbation in a liquid flowing through a section of the fluid conduit;
(c) an AC signal source; and
(d) first and second electrodes connected to the AC signal source, wherein the first and second electrodes are disposed adjacent to the conduit wall downstream of the perturbing device and are axially spaced from each other.

25. The apparatus according to claim 24 wherein the perturbing device includes a phase changing device adapted to change the phase of a portion of the liquid flowing through the fluid conduit.

26. The apparatus according to claim 24 wherein the perturbing device includes a heat transfer device adapted to cause a transfer of heat in a portion of the liquid flowing through a section of the fluid conduit.

27. The apparatus according to claim 24 wherein the perturbing device includes an electrochemical perturbation device adapted to cause an electrochemical perturbation in a portion of the liquid flowing through a section of the fluid conduit.

28. The apparatus according to claim 24 wherein the perturbing device includes a photochemical perturbation device adapted to cause a photochemical perturbation in a portion of the liquid flowing through a section of the fluid conduit.

29. The apparatus according to claim 24 wherein the first and second electrodes are radially spaced from an outer surface of the conduit wall to form a contactless conductivity detection device.

30. A liquid flow meter apparatus comprising:
(a) a fluid conduit including a non-conductive conduit wall;
(b) a phase changing device adapted to change the phase of a portion of the liquid flowing through the fluid conduit; and
(c) a conductivity detection device disposed adjacent to the conduit wall downstream of the phase changing device.

31. The apparatus according to claim 30 wherein the phase changing device includes a rapid cooling unit.

32. The apparatus according to claim 30 wherein the conductivity detection device includes an AC signal source and first and second electrodes connected to the AC signal source, wherein the first and second electrodes are disposed adjacent to the conduit wall and are axially spaced from each other.

33. A liquid flow meter apparatus comprising:
(a) a fluid conduit including a non-conductive conduit wall;
(b) a heat transfer device adapted to cause a transfer of heat in a portion of the liquid flowing through a section of the fluid conduit; and
(c) a conductivity detection device disposed adjacent to the conduit wall downstream of the heat transfer device.

34. The apparatus according to claim 33 wherein the heat transfer device includes a heating unit.

35. The apparatus according to claim 33 wherein the conductivity detection device includes an AC signal source and first and second electrodes connected to the AC signal source, wherein the first and second electrodes are disposed adjacent to the conduit wall and are axially spaced from each other.

36. A liquid flow meter apparatus comprising:
(a) a fluid conduit including a non-conductive conduit wall;
(b) an electrochemical perturbation device adapted to cause an electrochemical perturbation in a portion of the liquid flowing through a section of the fluid conduit; and
(c) a conductivity detection device disposed adjacent to the conduit wall downstream of the electrochemical perturbation device.

37. The apparatus according to claim 36 wherein the electrochemical perturbation device includes an electrode inserted into the fluid conduit in contact with the liquid flowing through the fluid conduit.

38. The apparatus according to claim 36 wherein the conductivity detection device includes an AC signal source and first and second electrodes connected to the AC signal source, wherein the first and second electrodes are disposed adjacent to the conduit wall and are axially spaced from each other.

39. A liquid flow meter apparatus comprising:
(a) a fluid conduit including a non-conductive conduit wall;
(b) a photochemical perturbation device adapted to cause a photochemical perturbation in a portion of the liquid flowing through a section of the fluid conduit; and
(c) a conductivity detection device disposed adjacent to the conduit wall downstream of the photochemical perturbation device.

40. The apparatus according to claim 39 wherein the photochemical perturbation device includes a light-emitting device adapted to direct light energy towards the section of the fluid conduit.

41. The apparatus according to claim 39 wherein the conductivity detection device includes an AC signal source and first and second electrodes connected to the AC signal source, wherein the first and second electrodes are disposed adjacent to the conduit wall and are axially spaced from each other.

42. A method for measuring the velocity at which a liquid is flowing through a fluid conduit comprising the steps of:
(a) conducting a liquid through a fluid conduit, the fluid conduit including a non-conductive wall;
(b) causing a volume of the liquid disposed in a first section of the fluid conduit to undergo a perturbation; and
(c) at a second section of the fluid conduit spaced downstream of the first section at a predetermined distance, detecting a change in conductivity in the liquid occurring as a result of the perturbation.

43. The method according to claim 42 comprising the step of timing the detection of the change in conductivity so as to occur at a predetermined time after the perturbation.

44. The method according to claim 42 wherein the step of causing the volume of liquid to undergo a perturbation includes causing the volume of liquid to undergo a phase change.

45. The method according to claim 44 wherein the step of causing the liquid volume to undergo a phase change includes directing a rapidly evaporating heat transfer fluid toward the first section of the fluid conduit.

46. The method according to claim 44 wherein the step of causing the liquid volume to undergo a phase change includes causing at least a portion of the liquid volume to change into a solid phase by causing heat energy to be rejected out of the fluid conduit.

47. The method according to claim 44 wherein the step of causing the liquid volume to undergo a rapid phase change includes causing at least a portion of the liquid volume to change into a gas phase by causing heat energy to be added into the fluid conduit.

48. The method according to claim 42 wherein the step of causing the liquid volume to undergo a perturbation includes the step of causing a transfer of heat to occur in at least of portion of the liquid volume.

49. The method according to claim 48 wherein the step of causing a transfer of heat to occur includes the step of adding heat energy to the portion of the liquid volume.

50. The method according to claim 48 wherein the step of causing the transfer of heat to occur includes the step of removing heat energy from the portion of the liquid volume.

51. The method according to claim 42 wherein the step of causing the liquid volume to undergo a perturbation includes the step of causing an electrochemical perturbation in at least of portion of the liquid volume.

52. The method according to claim 51 wherein the step of causing the electrochemical perturbation includes the steps of placing an electrode in contact with the liquid volume and energizing the electrode.

53. The method according to claim 42 wherein the step of causing the liquid volume to undergo a perturbation includes the step of causing a photochemical perturbation in at least of portion of the liquid volume.

54. The method according to claim 53 wherein the step of causing a photochemical perturbation includes the step of directing light energy towards the liquid volume.

55. The method according to claim 42 wherein the step of detecting a change in conductivity includes using a contactless conductivity detection device.

56. The method according to claim 42 comprising the steps of providing an AC signal source in electrical communication with at least two electrodes, and placing the electrodes adjacent to the conduit wall at the second section of the fluid conduit.

57. The method according to claim 42 wherein the step of detecting the change in conductivity includes capacitively coupling an AC signal between a first electrode and the liquid, and between a second electrode and the liquid.

58. A method for measuring the velocity at which a liquid is flowing through a fluid conduit comprising the steps of:
(a) conducting a liquid through a fluid conduit, the fluid conduit including a non-conductive wall;
(b) at a first section of the fluid conduit, causing a displacement of ions in the liquid to produce a zone of increased ionic concentration in the liquid and a zone of decreased ionic concentration in the liquid; and
(c) at a second section of the fluid conduit spaced downstream of the first section at a predetermined distance, detecting a change in conductivity in the liquid occurring as a result of the ion displacement.

59. The method according to claim 58 wherein the step of causing a displacement of ions includes causing a volume of the liquid disposed in the first section of the conduit to undergo a phase change.

60. A method for measuring the velocity at which a liquid is flowing through a fluid conduit comprising the steps of:
(a) providing a fluid conduit having a non-conductive wall;
(b) causing a volume of the liquid disposed in a first section of the fluid conduit to undergo a perturbation;
(c) providing an AC signal source;
(d) at a second section of the fluid conduit spaced downstream of the first section at a predetermined distance, placing at least two electrodes adjacent to the conduit wall and in electrical communication with the AC signal source; and
(e) capacitively coupling an AC signal supplied from the AC signal source between the first electrode and the liquid, and between the second electrode and the liquid.

61. A microfluidic device adapted to perform conductivity change detection operations, the chip comprising:
(a) a substrate;
(b) a fluid conduit formed on the substrate and including a non-conductive conduit wall;
(c) a perturbing device adapted to produce a localized perturbation in a liquid flowing through a section of the fluid conduit; and
(d) a conductivity detection device including at least two electrodes formed on the substrate, the at least two electrodes disposed adjacent to the conduit wall and downstream of the section or the fluid conduit at which the perturbation is produced.

62. A liquid flow monitoring and control apparatus comprising:
(a) a fluid conduit including a conduit wall;
(b) a perturbing device adapted to produce a localized perturbation in a liquid flowing through a section of the fluid conduit;
(c) a conductivity detection device operatively disposed downstream of the perturbing device in relation to the fluid conduit;
(d) a comparator device electrically communicating with the conductivity detection device and adapted to compare a value indicative of measured flow rate with a value indicative of preset flow rate; and
(e) a flow rate adjustment device operatively communicating with the comparator device.
